(19) United States
(12) Patent Application Publication
(10) Pub. No.: US 2020/0061932 A1
(43) Pub. Date: Feb. 27, 2020

(54) MOLDING APPARATUS AND MOLDING METHOD FOR LOOP STRUCTURE

(71) Applicants: NOK CORPORATION, Tokyo (JP); NOK Elastomers Processing Co., Ltd., Fukuoka (JP)

(72) Inventor: Hisayuki NAGAOKA, Fukuoka (JP)

(73) Assignees: NOK CORPORATION, Tokyo (JP); NOK Elastomers Processing Co., Ltd., Fukuoka (JP)

(21) Appl. No.: 16/545,419

(22) Filed: Aug. 20, 2019

(30) Foreign Application Priority Data
Aug. 22, 2018 (JP) 2018-155504

(51) Int. Cl. B29C 65/70; B29C 65/00

(52) U.S. Cl. CPC B29C 65/70; B29L 2031/709; B29C 66/0012; B29C 66/69

(57) ABSTRACT

A molding apparatus for a loop structure includes a molding die within which both ends of an elongated structure are located in such a manner that the ends are in contact with each other, the elongated structure being formed of a rubber to which a peroxide cross-linking agent is added; a liftable housing including a lower part having an opening, the housing defining a containment space within which the molding die and the elongated structure are located when the housing is lowered; a degassing device configured to depressurize and degas the containment space; a heating device configured to heat the molding die in the containment space; a pressure device configured to pressurize the ends of the elongated structure with the use of the heated molding die in the containment space to proceed cross-linking reaction of the rubber, thereby bonding the ends of the elongated structure; and an elevating device configured to lift and lower the housing.

### TECHNICAL FIELD

The present invention relates to molding apparatuses and to molding methods for loop structures of rubber materials to which peroxide cross-linking agent is added.

### BACKGROUND ART

Peroxide cross-linking reactions have been used for manufacturing fluororubber, ethylene-propylene-diene rubber, silicone rubber, high-saturated nitrile rubber, etc. (Patent Documents 1 and 2). The peroxide cross-linking reaction is conducted by adding organic peroxide as a cross-linking agent to a rubber material that is the primary component, and by applying heat and pressure to the obtained mixture. Rubber manufactured by peroxide cross-linking has excellent heat resistance and small compression permanent strain. Such rubbers are widely used, for example, for packing, gaskets, insulators, etc.

### BACKGROUND DOCUMENTS

### Patent Documents

Patent Document 1: JP-A-7-228706

Patent Document 2: JP-A-2010-70598

### SUMMARY OF THE INVENTION

In a process for manufacturing a loop structure, for example, an O-ring, an X-ring, or a D-ring from a rubber material, elongated structures that are not cross-linked containing a cross-linking agent is prepared, and both ends of the elongated structure are brought into contact with each other. Then, heat and pressure are applied to the ends of the elongated structure that are in contact with each other to proceed the cross-linking reaction of the rubber, thereby bonding the ends of the elongated structure.

However, in a case in which peroxide is used as a cross-linking agent, as described in Patent Documents 1 and 2, oxygen in the air prevents the progression of the peroxide cross-linking. In the step of applying heat and pressure to the two ends of the elongated structure described above, it is difficult to seal the ends of the elongated structure to which heat and pressure are applied, and the ends are easily exposed to the surrounding air, and therefore, the cross-linking may not be successfully accomplished.

Accordingly, the present invention provides a molding apparatus and a molding method for a loop structure to suitably proceed the cross-linking reaction even when a peroxide is used as the cross-linking agent.

A molding apparatus for a loop structure according to an aspect of the present invention includes: a molding die within which both ends of an elongated structure are located in such a manner that the ends are in contact with each other, the elongated structure being formed of a rubber to which a peroxide cross-linking agent is added; a liftable housing including a lower part having an opening, the housing defining a containment space within which the molding die and the elongated structure are located when the housing is lowered; a degassing device configured to depressurize and degas the containment space; a heating device configured to heat the molding die in the containment space; a pressure device configured to pressurize the ends of the elongated structure with the use of the heated molding die in the containment space to proceed cross-linking reaction of the rubber, thereby bonding the ends of the elongated structure; and an elevating device configured to lift and lower the housing.

A method of molding a loop structure according to an aspect of the present invention includes: locating both ends of an elongated structure within a molding die in such a manner that the ends are in contact with each other, the elongated structure being formed of a rubber to which a peroxide cross-linking agent is added; lowering a liftable housing including a lower part having an opening to provide a containment space for containing the molding die and the elongated structure; depressurizing and degassing the containment space; heating the molding die in the depressurized and degassed containment space; and pressurizing the ends of the elongated structure with the use of the heated molding die in the depressurized and degassed containment space to proceed cross-linking reaction of the rubber, thereby bonding the ends of the elongated structure.

In the aspects of the present invention, the housing is lowered to cover the molding die and the elongated structure for providing the containment space. Next, the containment space containing the molding die and the entirety of the elongated structure is depressurized and degassed. Inside the depressurized and degassed containment space, the molding die is heated, and both ends of the elongated structure are pressurized with the use of the molding die to proceed the cross-linking reaction of the rubber, whereby the ends of the elongated structure are bonded. Thus, the peroxide cross-linking reaction proceeds in a depressurized and degassed environment. Therefore, even though peroxide is used as the cross-linking agent, the cross-linking reaction suitably proceeds.

### BRIEF DESCRIPTION OF THE DRAWINGS

With reference to the accompanying drawings, an embodiment of the present invention will be described hereinafter. In the drawings:

FIG. 1 is a partially broken front view of a manufacturing apparatus for a loop structure according to an embodiment of the present invention;

FIG. 2 is a partially broken side view of the manufacturing apparatus;

FIG. 3 is a perspective view showing a molding die of the manufacturing apparatus; and

FIG. 4 is a side view showing the usage of the manufacturing apparatus.

### DESCRIPTION OF EMBODIMENT

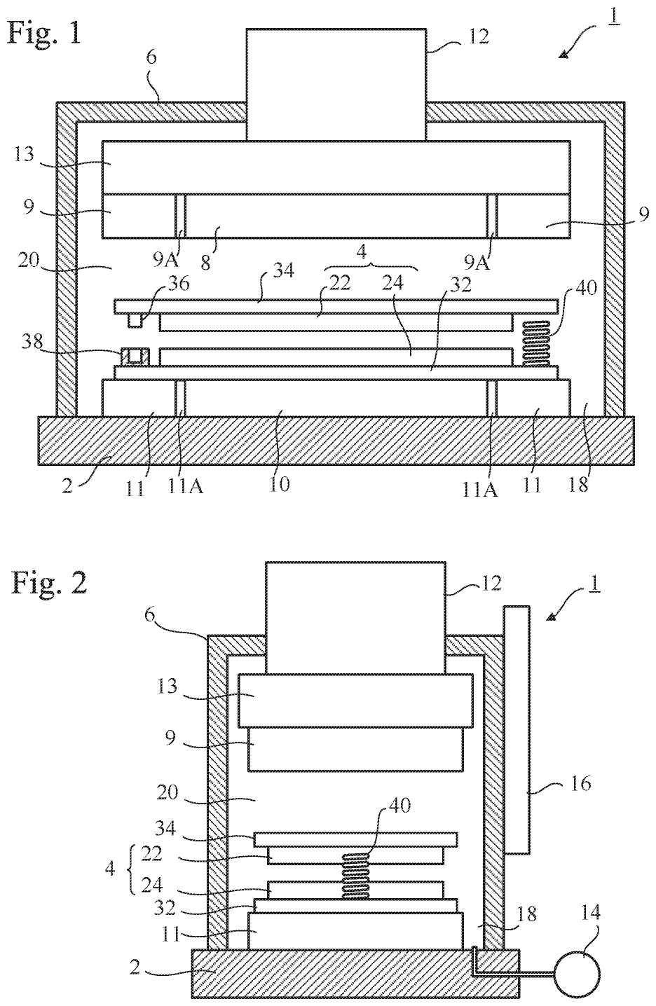

As shown in FIGS. 1 and 2, a manufacturing apparatus 1 for a loop structure 1 according to an embodiment includes a platform 2, a molding die 4, a housing 6, an upper heater (heating device) 8, a lower heater (heating device) 10, a pressurizing cylinder (pressure device) 12, a degassing pump (degassing device) 14, and an elevating device 16.

The platform 2 is a fixed platform that supports the molding die 4 and other components. The housing 6 is arranged so as to be movable up and down by the elevator device 16 with respect to the platform 2. The elevating device 16 is, for example, a hydraulic cylinder, a pneumatic cylinder, a rack and pinion, or other driving device, and raises and lowers the housing 6.

The housing 6 is of a box shape having an opening 18 at the lower part thereof. When the housing 6 is lowered, the housing 6 cooperates with the platform 2 to define a containment space 20. The degassing pump 14 depressurizes and degasses the containment space 20.

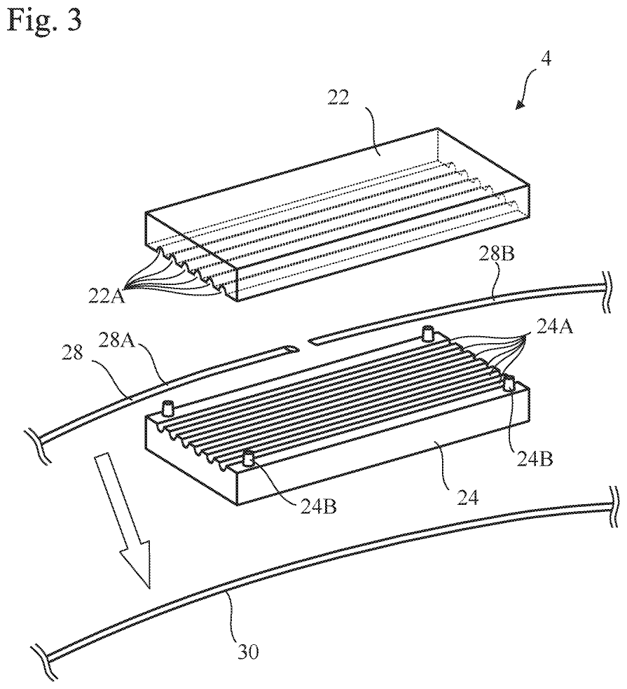

The molding die 4 is a metallic mold, and as shown in FIG. 3, includes an upper die 22 and a lower die 24. On the lower surface of the upper die 22, multiple semi-cylindrical shaping grooves 22A are formed and are arranged parallel to one another. Multiple semi-cylindrical shaping grooves 24A are also formed on the upper surface of the lower die 24, and the shaping grooves 24A are arranged parallel to one another. The shaping grooves 22A are respectively aligned with the shaping grooves 24A to form multiple cylindrical shaping cavities.

In addition, multiple positioning pins 24B project from the upper surface of the lower die 24. The lower surface of the upper die 22 is formed with multiple holes (not shown) into which the positioning pins 24B are fitted. The positioning pins 24B are inserted into the holes so that the position of the upper die 22 is aligned with the lower die 24, resulting in the shaping groove 22A being respectively aligned with the shaping groove 24A. Conversely, the positioning pin 24B may be fixed to the upper die 22 and corresponding holes may be formed in the lower die 24.

Each of the shaping cavities of the molding die 4 is used to form an O-ring (loop structure) 30. Specifically, one end 28A and the other end 28B of a rod, i.e., an elongated structure 28 formed of a rubber to which a peroxide cross-linking agent is added are placed in each shaping groove 24A. On this occasion, the ends 28A and 28B are brought into contact with each other, whereby the elongated structure 28 form a single loop. Both ends 28A and 28B of the elongated structure 28 are in a state in which cross-linking is not yet sufficient.

Thereafter, the upper die 22 is stacked on the lower die 24, such that both ends 28A and 28B of the respective elongated structures 28 are disposed in the shaping cavities each constituted of a pair of the shaping grooves 22A and 24A. Heat and pressure are applied to both ends 28A and 28B of each elongated structure 28 by using the molding die 4 to advance the cross-linking reaction of the rubber for bonding both ends 28A and 28B. In this way, loop, i.e., endless O-rings 30, are completed.

As is apparent from FIG. 3, each of the shaping cavities formed by a pair of shaping grooves 22A and 24A is a cylindrical space having open ends. In an environment in which there is air around the molding die 4, the air intrudes into the shaping cavities, and both ends 28A and 28B are exposed to the air. However, in this embodiment, the step of cross-linking of the rubber at both ends 28A and 28B is conducted under a depressurized and degassed environment.

As shown in FIG. 1, a lower heater 10 and two lower cooling plates 11 are mounted on the upper surface of the platform 2. The lower cooling plates 11 are disposed in the vicinity of both ends of the lower heater 10, whereas a heat shield plate 11A is interposed between each cooling plate 11 and the lower heater 10. The cooling plates 11 are plates formed of, for example, metal, whereas the heat shield plates 11A are plates formed of a heat insulating material. A lower supporting plate 32 is mounted on the lower heater 10, the cooling plates 11, and the heat shield plates 11A so as to be laterally slidable with respect to the lower heater 10, the cooling plates 11, and the heat shield plates 11A. The lower die 24 is fixed to the lower supporting plate 32.

On the other hand, the upper die 22 is fixed to the upper supporting plate 34 so as to face the lower die 24. A pressurizing cylinder 12 is disposed above the upper supporting plate 34. The pressurizing cylinder 12 is, for example, a hydraulic cylinder or a pneumatic cylinder, and has a cylinder head 13 that can be moved up and down. An upper heater 8 and two upper cooling plates 9 are fixed to the lower surface of the cylinder head 13. The upper cooling plates 9 are disposed in the vicinity of both ends of the upper heater 8, whereas a heat shield plate 9A is interposed between each cooling plate 9 and the upper heater 8. The cooling plates 9 are plates formed of, for example, metal, whereas the heat shield plates 9A are plates formed of a heat insulating material. The upper supporting plate 34 can slide laterally with respect to the upper heater 8, the cooling plates 9, and the heat shield plates 9A.

When the cylinder head 13 of the pressurizing cylinder 12 is lowered, the upper heater 8 and the cooling plates 9 are brought into contact with the upper surface of the upper supporting plate 34, and the upper die 22 is brought together with the lower die 24, resulting in both ends 28A and 28B of the elongated structure 28 being pressurized by the molding die 4. The heaters 8 and 10 heat the molding die 4. Therefore, the cross-linking of the rubber at both ends 28A and 28B of the elongated structure 28 is advanced. Thus, the pressurizing cylinder 12 presses both ends 28A and 28B of the elongated structure 28 with the use of the heated molding die 4 in the containment space 20 to proceed the cross-linking of the rubber, thereby bonding the ends of the elongated structure 28. The cooling plates 9 and 11 are separated from the heaters 8 and 10 by the heat shielding plates 9A and 11A formed of a heat insulating material, so that the heat generated by the heaters 8 and 10 is suppressed from being transmitted to the cooling plates 9 and 11. Accordingly, it is possible to effectively cause a temperature difference to occur between the central portion and the end portions of the metallic mold, for heating the both ends 28A and 28B of the elongated structure 28 while suppressing heating of other portions of the elongated structure 28.

In order to position the upper supporting plate 34 with respect to the lower supporting plate 32 when the upper die 22 approaches the lower die 24, a positioning pin, i.e., knock pin 36, is fixed to the lower surface of the upper supporting plate 34, whereas a cylindrical knock-pin bush 38 is fixed to the upper surface of the lower supporting plate 32. When the upper supporting plate 34 is lowered, the knock pin 36 is inserted into the hole of the knock-pin bush 38 to appropriately position the upper supporting plate 34 with respect to the lower supporting plate 32. Conversely, the knock pin 36 may be fixed to the lower supporting plate 32, whereas the knock-pin bush 38 may be fixed to the upper supporting plate 34.

Additionally, a coil spring 40 is attached to the lower surface of the upper supporting plate 34 or the upper surface of the lower supporting plate 32. When the cylinder head 13 is raised, so that the force for pressing the upper supporting plate 34 downward is removed, the coil spring 40 urges the upper supporting plate 34 for separating the upper supporting plate 34 from the lower supporting plate 32, whereby the upper die 22 is separated from the lower die 24.

The cylinder head 13 of the pressurizing cylinder 12, the upper heater 8, the cooling plates 9, the heat shield plates 9A, the upper supporting plate 34, the upper die 22, the lower die 24, the lower supporting plate 32, the lower heater 10, the cooling plates 11, and the heat shield plates 11A are located in the internal space of the housing 6. That is to say, they are disposed inside the containment space 20 when the housing 6 is lowered. The containment space 20 is depressurized and degassed by the degassing pump 14, so that the step of cross-linking the rubber at both ends 28A and 28B of the elongated structure 28 is executed under a depressurized and degassed environment. The entirety of the pressurizing cylinder 12 may be disposed in the internal space of the housing 6, or the actuator portion of the pressurizing cylinder 12 may be disposed outside the housing 6.

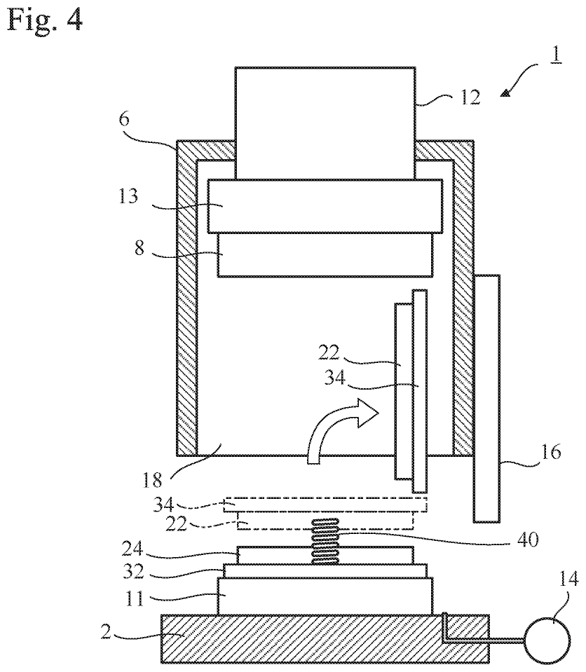

As shown in FIG. 4, the upper die 22 and the upper supporting plate 34 can rotate 90 degrees. For this reason, the upper die 22 and the upper supporting plate 34 are attached to a hinge device (not shown).

Next, a method of manufacturing a loop structure with the use of the loop structure manufacturing apparatus 1 will be described.

First, multiple elongated structures 28 in which the cross-linking is not sufficient at both ends 28A and 28B are prepared. The rubber material, which is the primary raw material of the elongated structure 28, may be, for example, any one of fluororubber, ethylene-propylene-diene rubber, isoprenoid rubber, silicone rubber, high-saturated nitrile rubber, styrene-butadiene rubber, chlorosulfonated polyethylene, acrylic rubber, urethane rubber.

The cross-linking agent added to the rubber material is a peroxide cross-linking agent, and may be for example, any one of, or a combination of 1,3-bis(t-butylperoxyisopropyl)benzene, 2,5-dimethyl-2,5-di(t-butylperoxy)oxy) hexyne-3, dicumyl peroxide, 2,4-dichlorobenzoyl peroxide, benzoyl peroxide, 2,5-dimethyl-2,5-dibenzoylperoxyhexane, n-butyl 4,4-di(t-butylperoxy)valerate, t-butylperoxybenzoate, di(t-butylperoxy)diisopropylbenzene, t-butylcumyl peroxide, 2,5-dimethyl-2,5-di(t-butylperoxy)hexane, di-t-butyl peroxide, and 2,5-dimethyl-2,5-di(t-butylperoxy)hexine-3. Other additives may be added to the rubber material.

Next, as shown in FIG. 4, with the housing 6 lifted from the platform 2 by the elevating device 16, both ends 28A and 28B of the prepared elongated structure 28 are placed in the respective shaping grooves 24A of the lower die 24 (see FIG. 3). At this stage, the upper die 22 and the upper supporting plate 34 are oriented vertically as shown by solid lines in FIG. 4.

Next, the upper die 22 and the upper supporting plate 34 are oriented horizontally as shown by the imaginary lines in FIG. 4. Then, the elevating device 16 is activated to lower the housing 6 to provide a containment space 20 that is isolated from the outside by means of the housing 6 and the platform 2 as shown in FIGS. 1 and 2.

Next, the degassing pump 14 is activated to decompress and degas the interior of the containment space 20.

Next, the pressurizing cylinder 12 is activated to lower the cylinder head 13, the upper heater 8, the cooling plates 9, and the heat shield plates 9A. In the course of the descent, the upper heater 8, the cooling plates 9, and heat shield plates 9A come into contact with the upper supporting plate 34 to begin to lower the upper supporting plate 34 and the upper die 22, and then the knock pin 36 enters the knock-pin bush 38 to align the position of the upper supporting plate 34 to the lower supporting plate 32 appropriately. Further, the positioning pin 24B of the lower die 24 enters the hole of the upper die 22 (see FIG. 3) to align the position of the upper die 22 appropriately with respect to the lower die 24.

Thus, as the cylinder head 13 descends, the upper die 22 is combined with the lower die 24, whereas both ends 28A and 28B of each elongated structure 28 are located inside the shaping cavity formed by a pair of shaping grooves 22A and 24A. Heat and pressure are applied to both ends 28A and 28B of elongated structures 28 with the use of the molding die 4 to proceed cross-linking of the rubber to bond the ends 28A and 28B, thereby completing O-rings 30.

Heating of the heaters 8 and 10 for applying heat to both ends 28A and 28B of the elongated structure 28 may be started before placing the elongated structure 28 in each shaping groove 24A of the lower die 24 (for example, the heaters 8 and 10 may be preheated). In order to suitably achieve the peroxide cross-linking reaction, the temperature of the heaters 8 and 10 is preferably increased after depressurizing and degassing the containment space 20 for controlling the temperature of the ends 28A and 28B to be suitable for cross-linking. For example, the temperature of the heaters 8 and 10 may be increased after the lower die 24 and the upper die 22 are combined.

Pressurization and heating to the ends 28A and 28B are performed for a predetermined time, and after expiration of the predetermined time, the pressurizing cylinder 12 is activated to raise the cylinder head 13. At this time, the positioning pin 24B is released from the hole of the upper die 22 by the repulsive force of the coil spring 40 (see FIG. 3), and the knock pin 36 is released from the knock-pin bush 38. In addition, the upper die 22 is separated from the lower die 24 and the O-rings 30.

Next, the elevating device 16 is activated to lift the housing 6 away from the platform 2 as shown in FIG. 4.

Next, the upper die 22 and the upper supporting plate 34 are oriented vertically as shown by the solid lines in FIG. 4. Thereafter, the completed O-rings 30 are removed from the lower die 24.

As described above, in this embodiment, inside the depressurized and degassed containment space 20, the molding die 4 is heated, and both ends of the elongated structure 28 are pressurized with the use of the molding die 4 to proceed the cross-linking reaction of the rubber, whereby the ends of the elongated structure 28 are bonded. Thus, the peroxide cross-linking reaction is proceeded in a depressurized and degassed environment. Therefore, even though peroxide is used as the cross-linking agent, the cross-linking reaction suitably proceeds.

In order to confirm the advantages of this embodiment, an experiment in which the ends of the elongated structures 28 are bonded to form O-rings 30 was conducted. In the experiment, bonding was performed under a depressurized and degassed environment according to the embodiment for multiple samples of elongated structures 28, whereas bonding was performed under an atmospheric environment for multiple samples of elongated structures 28 for comparison.

The composition of materials of the elongated structure 28 used in the experiment is as follows:

| | | |
|---|---|---|
| Rubber | Fluororubber (trade name | 100 parts by weight |
| Material | “Viton GLT-600S” purchased | |
| | from DuPont Elastomers Co., | |
| | Ltd., Tokyo, Japan) | |
| Reinforcing | Medium thermal carbon black | 30 parts by weight |
| Agent | (manufactured by Cancarb | |
| | Limited, Alberta, Canada) | |
| Cross-linking | Trade name “CALDIC | 4 parts by weight |
| Promoting Aid | #1000” manufactured by | |
| | Ohmi Chemical Industry Co., | |
| | Ltd., Shiga, Japan | |
| Cross-linking | Trade name “Diak No. 7” | 4 parts by weight |
| Aid | purchased from DuPont | |
| | Elastomers Co., Ltd. | |
| Cross-linking | Trade name “Perhexa | 4 parts by weight |
| Agent | 25B-40” manufactured by | |
| | NOF Corporation, Tokyo, Japan | |

The materials of the above composition were kneaded, and the obtained compound was molded by an extruder to obtain multiple rods having a diameter of 6.5 mm. The rods were then subjected to heat and pressure for 10 minutes in a depressurized and degassed environment. During heating, the temperature of the central portions of the rods was controlled to 180 degrees Celsius, whereas the temperature of the ends of the rods was controlled to 100 degrees Celsius. Thus, elongated structures 28 were obtained each having the central portion at which cross-linking was sufficiently performed and the ends at which cross-linking was not sufficiently performed.

Next, both ends 28A and 28B of each elongated structure 28 were placed in the longitudinal center of the shaping cavity of the molding die 4 in such a manner that the ends 28A and 28B overlapped in a length of 10 mm. Then, heat and pressure were applied to both ends for 10 minutes. The temperature at both ends during heating was 180 degrees Celsius. Thus, peroxide cross-linking reaction was allowed to proceed at both ends 28A and 28B to bond the ends 28A and 28B, so that O-rings 30 were produced.

In some of the samples of the O-rings produced in the atmospheric environment, slight bubbling occurred in the joints corresponding to both ends. In addition, some of the samples of the O-rings produced in the atmospheric environment had streaky unevenness resulting from flow of materials in the molding process by the molding die 4. Such failure is indicative of insufficient peroxide cross-linking at the joints. The rate of rejection was about 10%.

On the other hand, the plurality of samples of the O-rings 30 produced under the depressurized and degassed environment according to the embodiment were all good. Therefore, the superiority of the embodiment was confirmed.

While the present invention has been particularly shown and described with references to a preferred embodiment thereof, it will be understood by those skilled in the art that various changes in form and details may be made therein without departing from the scope of the invention as defined by the claims. Such variations, alterations, and modifications are intended to be encompassed in the scope of the present invention.

For example, in the above embodiment, O-rings 30 are manufactured by joining ends of the elongated structures 28 having a circular cross section. However, a D-ring may be manufactured by joining ends of an elongated structure having a D-shaped cross section. An X-ring may also be manufactured by joining ends of an elongated structure having an X-shaped cross section. Other loop structures with other cross-sectional shapes may also be manufactured.

In the above embodiment, the molding die 4 has multiple shaping cavities constituted by shaping grooves 22A and 24A, so as to be able to manufacture multiple loop structures at one time. However, only one single loop structure may be manufactured at one time with the use of a molding die having a single shaping cavity.

### REFERENCE SYMBOLS

1: Manufacturing Apparatus for Loop Structure
2: Platform
4: Molding Die
6: Housing
8: Upper Heater (Heating Device)
9: Upper Cooling Plates (Cooling Devices)
9A: Heat Shield Plates (Heat Shield Devices)
10: Lower Heater (Heating Device)
11: Lower Cooling Plates (Cooling Devices)
11A: Heat Shield Plates (Heat Shield Devices)
12: Pressurizing Cylinder (Pressure Device)
13: Cylinder Head
14: Degassing Pump (Degassing Device)
16: Elevating Device
18: Opening
20: Containment Space
22: Upper Die
24: Lower Die
22A: Shaping Grooves
24A: Shaping Grooves
30: O-ring (Loop Structure)
28: Elongated Structure
28A, 28B: Ends

What is claimed is:

1. A molding apparatus for a loop structure, comprising:
a molding die within which both ends of an elongated structure are located in such a manner that the ends are in contact with each other, the elongated structure being formed of a rubber to which a peroxide cross-linking agent is added;
a liftable housing comprising a lower part having an opening, the housing defining a containment space within which the molding die and the elongated structure are located when the housing is lowered;
a degassing device configured to depressurize and degas the containment space;
a heating device configured to heat the molding die in the containment space;
a pressure device configured to pressurize the ends of the elongated structure with the use of the heated molding die in the containment space to proceed cross-linking reaction of the rubber, thereby bonding the ends of the elongated structure; and
an elevating device configured to lift and lower the housing.

2. The apparatus according to claim 1, further comprising:
cooling devices located at both sides of the heating device; and
heat shield devices interposed between the heating device and the cooling devices,
wherein the heating device is configured to heat a longitudinal center of the molding die in which the ends of the elongated structure are located, and
wherein the cooling devices are configured to cool longitudinal ends of the molding die.

3. A method of molding a loop structure, comprising:
locating both ends of an elongated structure within a molding die in such a manner that the ends are in contact with each other, the elongated structure being formed of a rubber to which a peroxide cross-linking agent is added;
lowering a liftable housing comprising a lower part having an opening to provide a containment space for containing the molding die and the elongated structure;
depressurizing and degassing the containment space;
heating the molding die in the depressurized and degassed containment space; and
pressurizing the ends of the elongated structure with the use of the heated molding die in the depressurized and degassed containment space to proceed cross-linking reaction of the rubber, thereby bonding the ends of the elongated structure.

4. The method according to claim 3, wherein heating the molding die comprises heating a longitudinal center of the molding die in which the ends of the elongated structure are located, cooling longitudinal ends of the molding die, and heat-shielding the longitudinal ends of the molding die from the longitudinal center of the molding die.
